(19) United States
(12) Patent Application Publication
(10) Pub. No.: US 2019/0255722 A1
(43) Pub. Date: Aug. 22, 2019

(54) BLADE SHEATH DEVICE

(71) Applicant: Brent Short, Roslindale, MA (US)

(72) Inventor: Brent Short, Roslindale, MA (US)

(21) Appl. No.: 16/271,118

(22) Filed: Feb. 8, 2019

Related U.S. Application Data
(60) Provisional application No. 62/631,713, filed on Feb. 17, 2018.

(51) Int. Cl. B26B 29/02

(52) U.S. Cl. CPC B26B 29/025; B23D 49/10

(57) ABSTRACT

In some embodiments, a blade sheath device may include an elongated body having a mouth and a terminus. A central depression may be disposed on a first side of the body and may extend between the mouth and terminus. A perimeter lip may extend around portions of the central depression. An optional handle guard may be positioned proximate to the mouth, and may extend away from the mouth. A retaining cover, which may be coupled to the perimeter lip, may extend over portions of the central depression. One or more magnet elements may be coupled to the body proximate to the central depression. A securement fastener may be coupled to the device on a second side of the body. Optionally, the device may comprise one or more apertures which extend through and between the opposing sides of the device, such as through the body and/or through a handle guard.

### CROSS REFERENCE TO RELATED APPLICATIONS

This application claims priority to and the benefit of the filing date of U.S. Provisional Application No. 62/631,713, filed on Feb. 17, 2018, entitled “BLADE SHEATH DEVICE”, which is hereby incorporated by reference in its entirety.

### FIELD OF THE INVENTION

This patent specification relates to the field of devices configured to protect the blade of tools and implements. More specifically, this patent specification relates to devices which are able to cover and protect blades, such as saw blades and other toothed blades, commonly found on saws and other implements.

### BACKGROUND

Many types of tools and implements utilize a fixed blade. These fixed blades may be generally smooth or may be shaped and contoured such as toothed or saw blades. While fixed blades are robust and suitable for hard use activities, the blade is always exposed and may inadvertently come into contact with other objects. At best, inadvertent contact with an object may dull the blade and/or damage the object. At worst, a blade coming into inadvertent contact with an object may result in various injuries and even serious injuries. For these reasons, sheaths and other coverings have been used to cover blades.

While sheaths and coverings exist for toothed blades or saw blades, they suffer from drawbacks that make effectively covering the blade needlessly challenging. For example, some blade sheaths rely on fasteners or clamps which are used to physically secure the sheath to the blade. However, these sheaths tend to be either quite difficult to engage with the blade, so as to be difficult to take off and/or put on, or they tend to be too easily engaged or disengaged with the blade, so as to be easily defeated and frequently fall off. Other sheaths provide a slip-on covering of all or portions of the blade, but these sheaths are also easily defeated and frequently fall off. Still other sheaths attempt to encase or surround the entire blade or implement, and are therefore excessively bulky and cumbersome.

Therefore, a need exists for novel devices configured to protect the blade of tools and implements. There is also a need for novel blade protection devices that are not difficult to take off and/or put on a blade or implement. A further need exists, for novel blade protection devices which are not easily defeated and frequently fall off. Finally, a need exists for novel blade protection devices which are not bulky or cumbersome.

### BRIEF SUMMARY OF THE INVENTION

A blade sheath device is provided which may be used to cover or protect all or portions of the blade of bladed implements and also may be used to carry and transport blades. The device may be configured to be used with a contoured bladed tool or implement, a toothed bladed tool or implement, or any other type of tool or implement having an actionable surface which a user may desire to cover or protect from inadvertent contact with other objects.

In some embodiments, a blade sheath device may include an elongated body having a first side, a second side, a mouth, and a terminus. A central depression may be disposed on the first side of the body and may extend between the mouth and terminus. A perimeter lip may extend around portions of the central depression. A retaining cover, which may be coupled to the perimeter lip, may extend over portions of the central depression. One or more magnet elements may be coupled to the body proximate to the central depression. The central depression may be generally complementary in shape to the blade of a bladed implement to be received by the device so that all or portions of the blade may be positioned in the central depression when the bladed implement is received by the device.

In further embodiments, a sheath device may include an elongated body having a mouth, a terminus, a first side, and a second side. A central depression may be disposed on the first side of the body and may extend between the mouth and the terminus. A perimeter lip may extend around portions of the central depression. A magnet element may be coupled to the body proximate to a depression surface of the central depression, and the magnet element may be configured to magnetically engage with a blade of a bladed implement when portions of the blade are positioned in the central depression. A first securement fastener may be coupled to the body, and a retaining cover may be coupled to the perimeter lip and may extend over portions of the central depression.

In further embodiments, the device may comprise a handle guard which may be positioned proximate to the mouth, and which may extend away from the mouth.

In still further embodiments, the device may comprise a securement fastener which may be coupled to the device on the second side of the body.

In even further embodiments, the device may comprise one or more apertures which extend through and between the opposing sides of the device, such as through the body and/or through a handle guard.

In some embodiments, the device 100 may comprise a handle guard loop 17 which may be coupled to the body 11 generally opposite to the terminus 13 and configured to extend away from the central depression 21 and terminus 13.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a top perspective view of an example of a blade sheath device according to various embodiments described herein and an exemplary bladed implement.

FIG. 2 illustrates a top perspective view of an exemplary bladed implement received by an example of a blade sheath device according to various embodiments described herein.

FIG. 3 shows a bottom perspective view of an example of a blade sheath device according to various embodiments described herein.

FIG. 4 shows a sectional, through line 4-4 shown in FIG. 2, elevation view of an exemplary bladed implement engaged by an example of a blade sheath according to various embodiments described herein.

FIG. 5 illustrates a top perspective view of another example of a blade sheath device according to various embodiments described herein.

FIG. 6 shows a top perspective view of yet a further example of a blade sheath device according to various embodiments described herein and an exemplary bladed implement.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

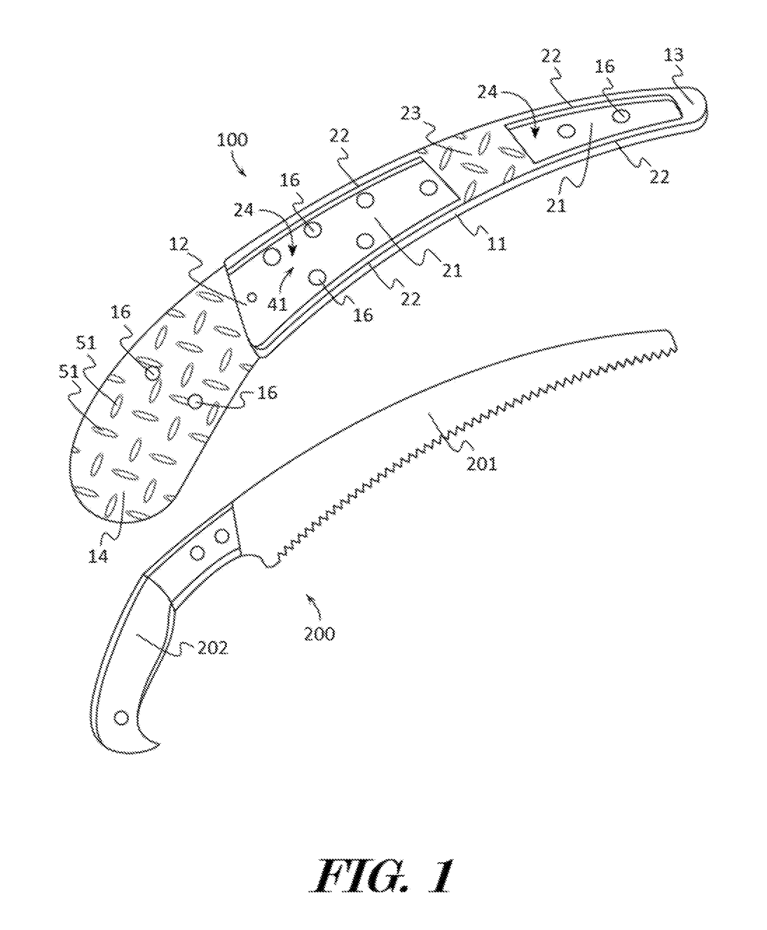

For purposes of description herein, the terms “upper”, “lower”, “left”, “right”, “rear”, “front”, “side”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first”, “second”, etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new device which is able to cover and protect blades, such as saw blades and other toothed blades, commonly found on saws and other bladed implements is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

The present invention will now be described by example and through referencing the appended figures representing preferred and alternative embodiments. FIGS. 1-5 illustrate examples of a blade sheath device (“the device”) 100 according to various embodiments described herein and an exemplary bladed implement 200 according to various embodiments. The device 100 may be used to cover or protect all or portions of the blade 201 of bladed implements 200. A bladed implement 200 may include any tool or object having a blade which may be used to cut, scrape, saw, or otherwise manipulate various materials. The bladed implement 200, having a toothed blade 201, may generally be referred to as a hand saw, but the device 100 may be configured to be used with any type of bladed tool or implement, such as pole saws, hacksaws, keyhole saws, bow saws, any other type of toothed tool or implement, machetes, swords, axes, any other type of generally smooth or contoured bladed toothed tool or implement, and/or any other type of tool or implement having an actionable surface which a user may desire to cover or protect from inadvertent contact with other objects.

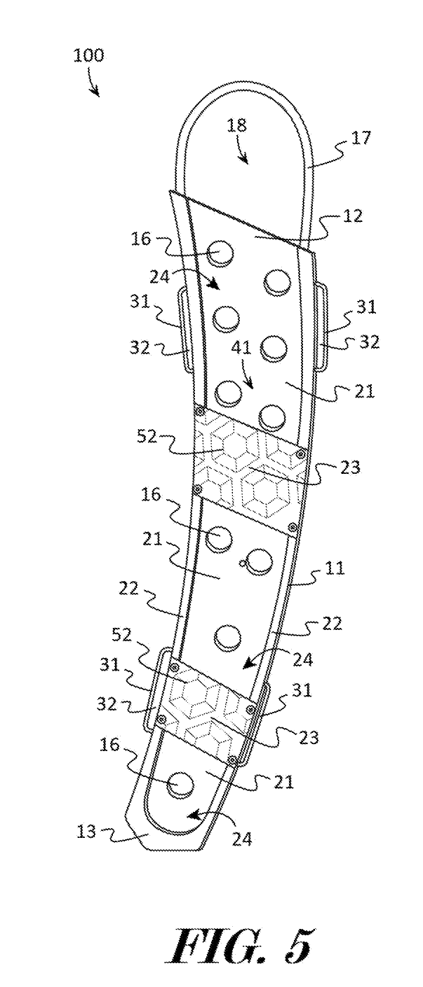

Referring now to FIGS. 1-3 and 5, and in some embodiments, the device 100 may comprise an elongated body 11 having a mouth 12 and a terminus 13. A central depression 21 may be disposed on a first side 41 of the body 11 and may extend between the mouth 12 and terminus 13. A perimeter lip 22 may extend around portions of the central depression 21. An optional handle guard 14 may be positioned proximate to the mouth 12. Generally, the handle guard 14 may extend away from the mouth 12. A retaining cover 23, which may be coupled to the perimeter lip 22, may extend over portions of the central depression 21. One or more magnet elements 15 (FIG. 4) may be coupled to the body 11 proximate to the central depression 21. A securement fastener 31 may be coupled to the device 100 on a second side 42 of the body 11. Optionally, the device 100 may comprise one or more apertures 16 which extend through and between the opposing sides 41, 42, of the device 100, such as through the body 11 and/or through a handle guard 14.

The body 11 may be elongated in shape, having a length that is greater than its width and depth, and preferably made from a substantially rigid and durable material. The body 11 may be configured in any shape and size, but preferably with a size that is larger than the blade 201 of the bladed implement 200 to be received by the device 100. Generally, a mouth 12 may be disposed at one end of the length of the body 11, while the terminus 13 may be disposed at the other or opposing end of the length of the body 11.

In preferred embodiments, the body 11 may be made from or comprise a substantially rigid material optionally having a diamond plate texturing 51, hexagonal texturing 52, or any other texturing. In further embodiments, the body 11 may be made from steel alloys, aluminum, aluminum alloys, copper alloys, any other type of metal or metal alloy, any type of ceramic, thermoplastics, such as polyethylene (PE), polypropylene (PP) and polyvinyl chloride (PVC), polycarbonate, nylon, Poly(methyl methacrylate) (PMMA) also known as acrylic, natural rubber, such as vulcanized rubber, synthetic rubber, such as styrene-butadiene rubber, melamine, fiberglass, carbon fiber, resins, such as epoxy resin, wood, or any other material including combinations of materials that are substantially rigid and durable.

The body 11 may be generally planar in shape having a generally planar first side 41 and a generally planar and opposing second side 42. In some embodiments, the central depression 21 may be disposed on the first side 41 of the device 100. In preferred embodiments, the central depression 21 may be complementary in shape to the blade 201 of the bladed implement 200 to be received by and protected by the device 100. A central depression 21 may comprise a depression surface 24, and a perimeter lip 22 may bound or extend around portions of the depression surface 24 to form the central depression 21. The perimeter lip 22 may not extend around the mouth 12, thereby allowing portions of a blade 201 to be moved into and out of the central depression 21 via the mouth 12. In preferred embodiments, a central depression 21 may have a width (W) as measured from opposing portions of the perimeter lip 22 on opposing sides of the central depression 21 and as shown in FIG. 4 that is 5% to 10% greater than the width of the portions of the blade 201 to be received in the central depression 21. In further embodiments, a central depression 21 may have a width (W) that is 1% to 20% greater than the width of the portions of the blade 201 to be received in the central depression 21. In further preferred embodiments, and as best shown in FIGS. 1, 2, and 5, the width (W) of the central depression 21 may be tapered so that the width (W) of the central depression 21 proximate to the terminus 13 may be less than the width (W) of the central depression 21 proximate to the mouth 12.

A perimeter lip 22 may extend up and away from the depression surface 24 of the body 11 a distance that is greater than the depth of the portions of the blade 201 to be received in the central depression 21. In preferred embodiments, a perimeter lip 22 may extend up and away from the depression surface 24 a distance that is 5% to 10% greater than the depth of the portions of the blade 201 to be received in the central depression 21. In further embodiments, a perimeter lip 22 may extend up and away from the depression surface 24 a distance that is 1% to 20% greater than the depth of the portions of the blade 201 to be received in the central depression 21.

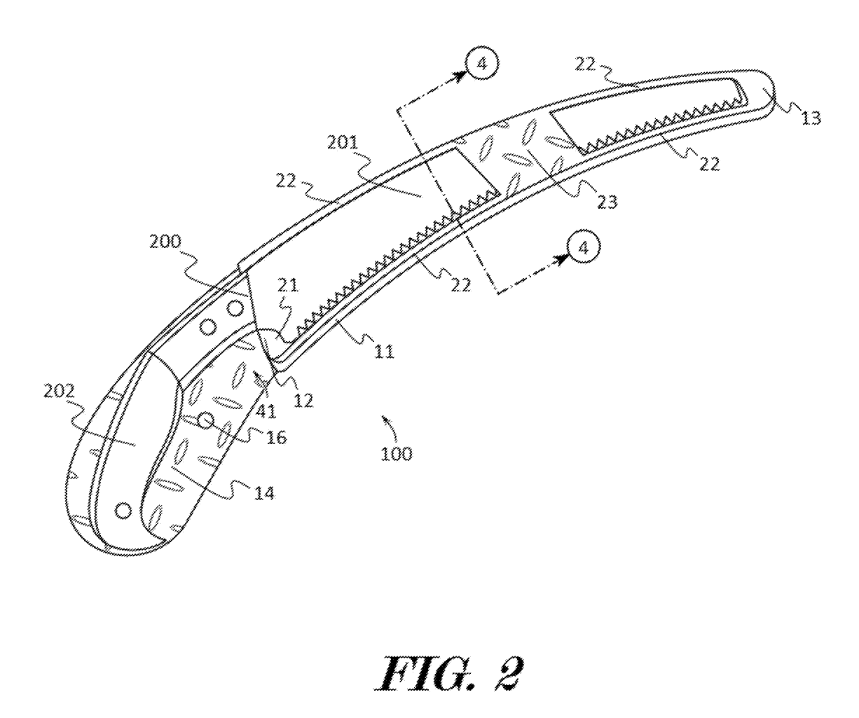

In some embodiments, the device 100 may comprise one or more retaining covers 23 which may be coupled to the perimeter lip 22 and which may extend over portions of the central depression 21. A retaining cover 23 may be positioned anywhere over the central depression 21, such as between the mouth 12 and terminus 13, and preferably approximately midway between the mouth 12 and terminus 13. As shown in FIGS. 1 and 2, in some embodiments, a retaining cover 23 may comprise a generally rectangular shape and cover approximately 10% of the central depression 21. In other embodiments, one or more retaining covers 23 may comprise any other shape and cover between 1% and 100% of the central depression 21. In preferred embodiments, a retaining cover 23 may be made from or comprise a substantially rigid material having a diamond plate texturing.

Optionally, the device 100 may comprise a handle guard 14 which may be positioned proximate to the mouth 12. In preferred embodiments, the handle guard 14 may extend away from the mouth 12 and have a shape that is substantially complementary to the shape of the handle 202 of the bladed implement 200 to be received by the device 100. In some embodiments, a handle guard 14 may be removably coupled to the body 11, while in other embodiments, a handle guard 14 may be integrally formed or otherwise permanently coupled to the body 11. In preferred embodiments, a handle guard 14 may be made from or comprise a substantially rigid material having a diamond plate texturing.

As perhaps best shown in FIG. 4 and in some embodiments, the device 100 may comprise one or more magnet elements 15 which may be coupled and positioned anywhere on the body 11 such as proximate to the central depression 21. Generally, a magnet element 15 may magnetically engage with portions of the blade 201 of a bladed implement 200 received in the central depression 21 of the device 100 to magnetically engage with the blade 201 of a bladed implement 200 when portions of the blade 201 are positioned in the central depression 21. In preferred embodiments and as shown in FIG. 4, one or more magnet elements 15 may be coupled to the body 11 proximate to the depression surface 24 of the central depression. In further embodiments, a magnet element 15 may be integrally formed or molded within the body 11. In other embodiments, a magnet element 15 may be sandwiched between portions of a handle guard 14 and portions of the body 11. In still further embodiments, a magnet element 15 may be coupled to or disposed within a retaining cover 23.

A magnet element 15 may be made from or comprise a magnetic material such as ferrite, ferric oxide mixed with a binder, manganese-zince ferrite, nickel-zinc ferrite, strontium ferrite, cobalt ferrite, barium ferrite, magnetic alloys such as alnico, comol, hypernom, iron-silicon magnet alloys, magnet steel, chromindur, silmanal, platinax, bismanol, cobalt-platinum alloys, chromium-manganese antimonide, ultra-mag, vectolite, magnadur, lodex, awaruite, wairauite, rare earth magnets such as samarium-cobalt, cesium-cobalt, neodymium-iron-boron, other neodymium magnet materials, metallic oxides such as magnetite, ulvospinel, hematite, ilmenite, maghemite, jacobsite, metallic sulfides such as pyrrhotite, greigite, troilite, metallic oxyhydroxides such as goethite, lepidocrocite, feroxyhyte, ferromagnetic materials and ferrimagnetic materials, including metals such as iron, nickel, cobalt, metal alloys containing iron, nickel, and/or cobalt, or any other suitable magnetic material, that is capable of magnetically adhering to another magnetic material through the principle of magnetism.

In some embodiments, the device 100 may comprise one or more securement fasteners 31 may be which may be coupled anywhere on the device 100. A securement fastener 31 may be used to couple the device 100, and therefore a bladed implement received by the device 100, to one or more other objects, such as a belt, the waist area of pants, a pocket, jackets, other clothing options, bags, saddles, harnesses, other tool and equipment, or any other object. In some exemplary embodiments, a securement fastener 31 may be disposed on the second side 42 of the body 11, such as to an optional handle guard 14.

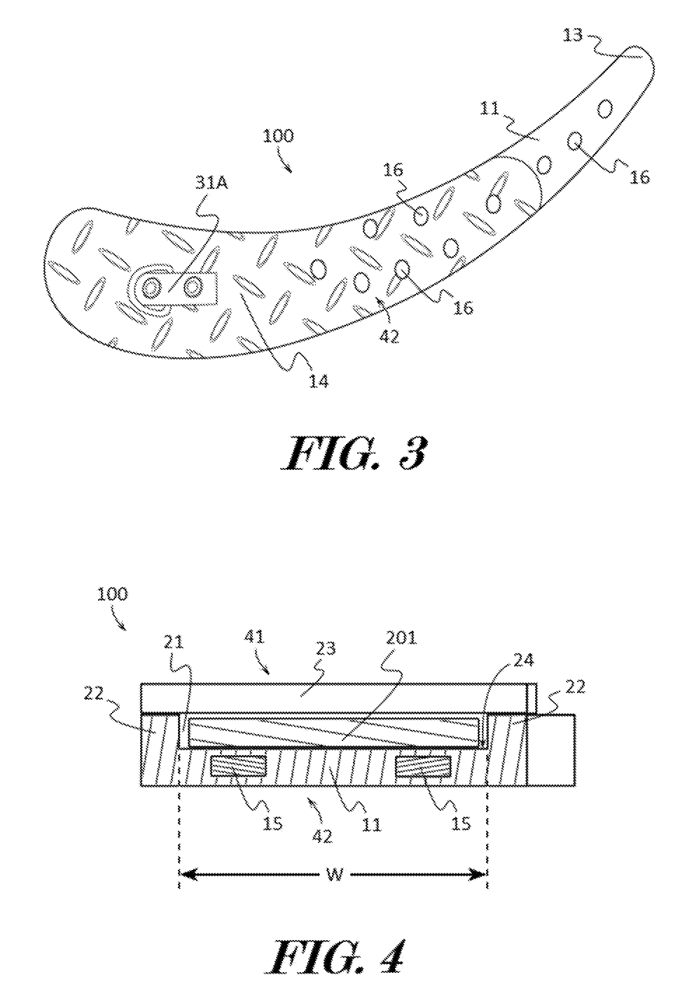

In preferred embodiments, a securement fastener 31 may comprise a D-ring fastener 31A as shown in FIG. 3. In other embodiments, a securement fastener 31 may comprise any other type of fastener including a buckle, cable tie, captive fastener, clamp (or cramp), hose clamp, clasps, lobster clasp, cleko, clips, circlip, hairpin clip, paper clip, terry clip, clutch, drawing pin (thumbtack), flange, grommet, hook-and-eye closure, hook and loop fastener, latch, nail, pegs, clothespin, tent peg, PEM nut, pins, bowtie cotter pin, circle cotter, clevis fastener, cotter, dowel, linchpin, R-clip, split pin, spring pin, tapered pin, retaining rings, circlip, e-ring, rivet, rubber band (or bands of other materials), screw anchor, snap fastener, staple, stitches, strap, threaded fastener, captive threaded fasteners, nut, screw, threaded insert, threaded rod, tie, toggle bolt, treasury tag, twist tie, and wedge anchor.

In some embodiments, the device 100 may comprise one or more apertures 16 which may extend through and between the opposing sides 41, 42, of the device 100, such as through the body 11 and/or through a handle guard 14. In preferred embodiments, one or more apertures 16 may be disposed in the central depression 21 and may extend through and between the opposing sides 41, 42, of the device 100. Generally, an aperture 16 may allow air flow to prevent moisture, dirt, and other contaminants from accumulating in the device 100 or on the blade 201 of a bladed implement received by the device 100.

An aperture 16 may be configured in any size and shape, such as a rounded shape as depicted in FIGS. 1-3. However, it should be understood to one of ordinary skill in the art that an aperture 16, body 11, handle guard 14, central depression 21, or any other element discussed herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

FIGS. 2 and 4 shows an exemplary bladed implement 200 engaged by an example of a blade sheath device 100 according to various embodiments described herein. Preferably, portions of the blade 201 may be inserted or otherwise deposited in the central depression 21 through the mouth 12. Optionally, the end or tip of the blade 201 may contact or be placed proximate to the terminus 13. Once in the central depression 21, the perimeter lip 22 may extent around the blade 201 to cover or protect the working edge of the blade 201 from inadvertent contact with other objects. Additionally, the one or more magnet elements 15 may magnetically retain the blade 201 within the central depression 21, while a retaining cover 23 further prevents the blade 201 from being dislodged from the central depression 21.

FIG. 5 illustrates a top perspective view of another example of a blade sheath device 100. In some embodiments, the device 100 may comprise two or more retaining covers 23 which may be coupled to the perimeter lip 22 or other portion of the body 11. The retaining covers 23 may be configured in any shape and size thereby allowing each retaining cover 23 to cover a desired portion of the central depression 21. In preferred embodiments, the device 100 may comprise a first retaining cover 23 which may be positioned relatively proximate to the terminus 13 and a second retaining cover 23 which may be positioned relatively distal to the terminus 13. Optionally, a retaining cover 23 may be coupled to portions of the body 11, such as the perimeter lip 22, with one or more rivet type fasteners although any other coupling method may be used.

In some embodiments, the device 100 may comprise one or more securement fasteners 31 which may be coupled to the body 11 and configured to generally extend away from the perimeter lip 22. As shown in the example of FIG. 5, a device 100 may comprise a first set of two securement fasteners 31 which may be positioned relatively proximate to the terminus 13 and a second set of two securement fasteners 31 which may be positioned relatively distal to the terminus 13. In preferred embodiments, a first securement fastener 31 and second securement fastener 31 of a set may be coupled to the body 11 on opposing sides of the central depression 21. Preferably, each securement fastener 31 of a set of securement fasteners 31 may comprise an elongated channel 32 which may be shaped to receive objects, such as belts, straps, cord, and ties, which may be used to secure the device 100 to other objects. For example, a first nylon webbing strap may be inserted through both channels 32 of a first set of securement fasteners 31 and a second nylon webbing strap may be inserted through both channels 32 of a second set of securement fasteners 31 so that the straps may be wrapped around the leg of a user thereby allowing the device 100 to be secured to the user's leg via the straps and securement fasteners 31. In further embodiments, a securement fastener 31 may be configured in any shape and size and may be positioned anywhere on the device 100.

In some embodiments, the device 100 may comprise a handle guard loop 17 which may be coupled to the body 11 generally opposite to the terminus 13 and configured to extend away from the central depression 21 and terminus 13. Preferably, the handle guard loop 17 may comprise a length of durable material, such as braided steel cable, which may be coupled to the body 11 to form an opening 18 through which objects may be inserted such as belts, carabiners, etc. In further embodiments, a handle guard loop 17 may be configured in any shape and size to form an opening 18 of any shape and size. In alternative embodiments, a handle guard 14 may be configured as a handle guard loop 17. In further alternative embodiments, a handle guard loop 17 may be configured as a handle guard 14.

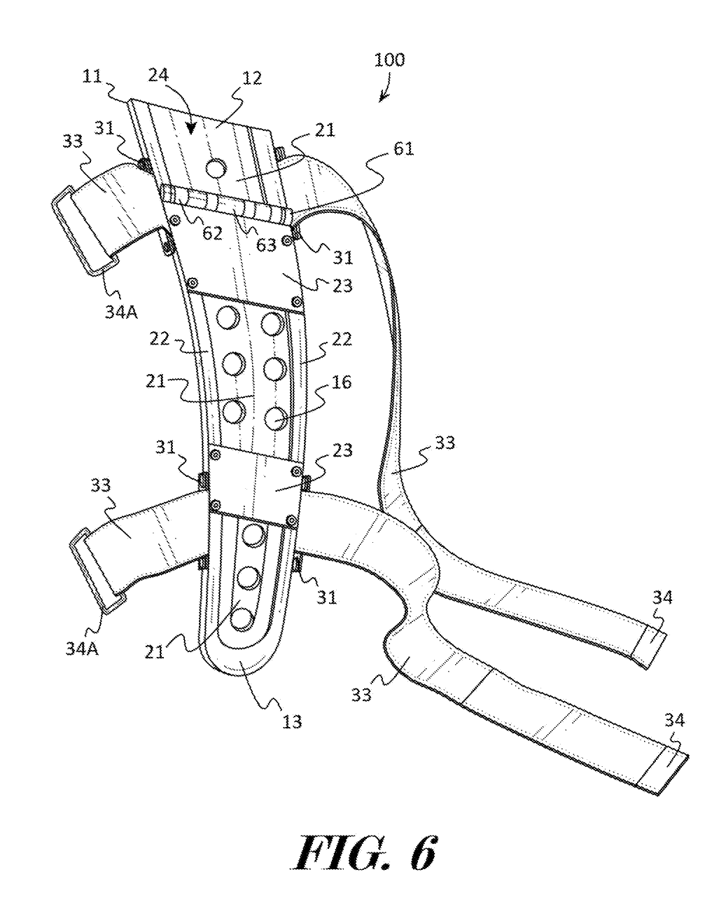

FIG. 6 illustrates yet a further example of a device 100. In some embodiments, the device 100 may comprise a one or more flexible retainers 33. A flexible retainer 33 may be configured to secure or couple the device 100 to objects such as a leg or other body part of a user. In further embodiments, a flexible retainer 33 may be coupled to a securement fastener 31, such as by being received in two or more securement fasteners 31, such as through the channel 32 of each securement fastener 31. For example, a first flexible retainer 33 may be inserted through the respective channels 32 of a first securement fastener 31 and second securement fastener 31 that are coupled to the body 11 on opposing sides of the central depression 21 relatively closer to the mouth 12, and a second flexible retainer 33 may likewise be inserted through the respective channels 32 of a third securement fastener 31 and fourth securement fastener 31 that are coupled to the body 11 on opposing sides of the central depression 21 relatively closer to the terminus 13.

In some embodiments, a flexible retainer 33 may be configured generally as a strap or belt made of or comprising a flexible material such as nylon webbing. In further embodiments, a flexible retainer 33 may be made from or comprise a flexible material such nylon webbing, polypropylene webbing, polyester webbing, various types of flexible plastics such as polyvinyl chloride, natural or synthetic rubber, neoprene foam rubber, synthetic fabrics such as polyester, nylon, rayon, acetate, spandex, spandex blends, and Kevlar, and natural fabrics such as coir, cotton, hemp, jute, canvas, flax, leather, linen, ramie, wool, silk, or any other suitable flexible natural or synthetic material including combinations of materials.

In some embodiments, a flexible retainer 33 may comprise one or more retainer fasteners 34 which may be configured to secure or couple portions of the flexible retainer 33 to itself and/or to other objects. In preferred embodiments, a flexible retainer 33 may comprise two or more retainer fasteners 34 which may be configured as hook-and-loop type (Velcro®) fasteners. In other embodiments, a retainer fastener 34 may be configured as a loop-type fastener 34A (or other strap hardware), press fit or snap fit fastener, magnetic type fastener, threaded type fastener, clip type fasteners, clasp type fasteners, or any other connection method.

In some embodiments, the device 100 may comprise one or more guides 61. Generally, a guide 61 may be positioned proximate to the central depression 21, such as proximate to the mouth 12, and configured to physically guide the insertion and/or removal of the blade 201 of a bladed implement 200 into and/or out of the central depression 21. In some embodiments, a guide 61 may be configured as a bar which may extend across the central depression 21. In other embodiments, a guide 61 may be configured in any other size and shape and/or may not extend completely across the central depression 21. Optionally, a guide 61 may be movably coupled to the body 11, such as via spring tension, to further allow the guide 61 to accept the insertion and/or removal of a blade 201 that is not completely aligned with the central depression 21 and its depression surface 24.

In preferred embodiments, a guide 61 may comprise one or more moving contacts 62 and/or one or more stationary contacts 63. A moving contact 62 may be movably coupled to the guide 61 so that as the moving contact 62 contacts a portions of a blade 201 as it is moving into or out of the central depression 21, the moving contact 62 may move relative to the guide 61. For example, a guide 61 may comprise a moving contact 62 which may be configured to revolve around the guide 61 or some other axis when the moving contact 62 contacts a portions of a blade 201 as it is moving into or out of the central depression 21 to reduce friction between the blade 201 and moving contact 62. A stationary contact 63 may be coupled to the guide 61 so that the stationary contact 63 may generally not be configured to move across the surface of the blade 201 but to slide across the surface. For example, a stationary contact 63 may comprise a low friction material, such as Teflon or other polymer, which may act as a skid plate or the like which may not revolve around the guide 61 or other axis but which may contact and slide across a portions of a blade 201 as it is moving into or out of the central depression 21 to reduce friction between the blade 201 and stationary contact 63. Optionally, a moving contact 62 and/or one or more stationary contact 63 may be movably coupled to the guide 61, so that the contact(s) 62, 63, may move towards and away from the guide 61, such as via spring tension, to further allow the guide 61 to accept the insertion and/or removal of a blade 201 that is not completely aligned with the central depression 21 and its depression surface 24.

While some materials have been provided, in other embodiments, the elements that comprise the device 100 such as the body 11, perimeter lip 22, optional handle guard 14, optional retaining cover 23, and/or any other element discussed herein may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the device 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the device 100 may be coupled by being one of connected to and integrally formed with another element of the device 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A blade sheath device, for use with a bladed implement, the device comprising:
an elongated body having a mouth, a terminus, a first side, and a second side;
a central depression disposed on the first side of the body and extending between the mouth and the terminus;
a perimeter lip extending around portions of the central depression;
a magnet element coupled to the body; and
a retaining cover coupled to the perimeter lip and extending over portions of the central depression.

2. The device of claim 1, wherein the magnet element is coupled to the body proximate to a depression surface of the central depression.

3. The device of claim 1, further comprising a guide.

4. The device of claim 3, wherein the guide comprises a moving contact.

5. The device of claim 1, wherein the guide comprises a stationary contact.

6. The device of claim 1, further comprising a first securement fastener.

7. The device of claim 6, further comprising a flexible retainer coupled to the securement fastener.

8. The device of claim 6, wherein the first securement fastener comprises an elongated channel.

9. The device of claim 1, further comprising a second securement fastener having an elongated channel, wherein the first securement fastener and second securement fastener are coupled to the body on opposing sides of the central depression.

10. The device of claim 1, wherein the central depression comprises a width as measured from opposing portions of the perimeter lip on opposing sides of the central depression, and wherein the width (W) of the central depression is tapered so that the width (W) of the central depression proximate to the terminus is less than the width (W) of the central depression proximate to the mouth.

11. The device of claim 1, further comprising an aperture disposed in the central depression.

12. A blade sheath device, for use with a bladed implement, the device comprising:
an elongated body having a mouth, a terminus, a first side, and a second side;
a central depression disposed on the first side of the body and extending between the mouth and the terminus;
a perimeter lip extending around portions of the central depression;
a magnet element coupled to the body proximate to a depression surface of the central depression, the magnet element configured to magnetically engage with a blade of the bladed implement when portions of the blade are positioned in the central depression;
a first securement fastener coupled to the body; and
a retaining cover coupled to the perimeter lip and extending over portions of the central depression.

13. The device of claim 12, further comprising a guide.

14. The device of claim 13, wherein the guide comprises a moving contact.

15. The device of claim 12, wherein the guide comprises a stationary contact.

16. The device of claim 12, further comprising a flexible retainer coupled to the securement fastener.

17. The device of claim 12, wherein the first securement fastener comprises an elongated channel.

18. The device of claim 12, further comprising a second securement fastener having an elongated channel, wherein the first securement fastener and second securement fastener are coupled to the body on opposing sides of the central depression.

19. The device of claim 12, wherein the central depression comprises a width as measured from opposing portions of the perimeter lip on opposing sides of the central depression, and wherein the width (W) of the central depression is tapered so that the width (W) of the central depression proximate to the terminus is less than the width (W) of the central depression proximate to the mouth.

20. The device of claim 12, further comprising an aperture disposed in the central depression.
